(19) United States
(12) Patent Application Publication
(10) Pub. No.: US 2026/0178839 A1
(43) Pub. Date: Jun. 25, 2026

(54) Method for Carrying Out an Automated Conversation Between Human and Machine and Conversational System Thereof

(71) Applicant: IIO SOCIETA' A RESPONSABILITA’ LIMITATA, Milano (IT)

(72) Inventor: Andrea CINELLI, Milano (IT)

(21) Appl. No.: 19/128,546

(22) PCT Filed: Nov. 9, 2023
(86) PCT No.: PCT/IB2023/061307

§ 371 Date: May 8, 2025

(30) Foreign Application Priority Data
Nov. 9, 2022 (IT) 102022000023100

(51) Int. Cl. G06F 40/35; G06F 40/289; G06N 3/006; G06N 3/08; G10L 13/02

(52) U.S. Cl. CPC G06F 40/35; G06F 40/289; G06N 3/006; G06N 3/08; G10L 13/02

(57) ABSTRACT

A method is disclosed for carrying out an automated conversation between a human user and a machine. The method includes providing a conversational graph representative of a user conversation flow in a defined conversation domain. The conversational graph includes a plurality of successively connected states. Each state includes at least one user node representative of a text of a phrase pronounced by the user and at least one agent node representative of a text of a respective at least one phrase automatically generated by a virtual conversational agent.

### TECHNICAL FIELD OF THE INVENTION

The present invention generally relates to the field of human-machine interaction. More particularly, the present invention concerns a method for carrying out an automated conversation between human and machine and conversational system thereof.

### PRIOR ART

Automated conversational systems are known to carry out a conversation between a human user and a virtual agent made in software.

The Applicant has observed that the known conversational systems fail to meet the users'expectations, due to varying contexts and large amount of possible questions, thus generating conversations that are inconsistent, unnatural and subject to a high number of errors in identifying the correct conversation state that require a large number of resources to refine such recognition.

### SUMMARY OF THE INVENTION

The present invention concerns a computer-implemented method for carrying out an automated conversation between human and machine as defined in the appended claim 1 and the preferred embodiments thereof described in the dependent claims from 2 to 9.

The Applicant has perceived that the method for carrying out an automated conversation in accordance with the present invention allows to improve the involvement of the user, i.e. to provide a pleasant and involving experience, by means of automated conversations that are robust, with responses that are not only consistent, but also diversified and deep (i.e. with an improved content), therefore accurate and natural, i.e. conversations that resemble those that take place between two human users.

The basic idea is to realize a conversational engine capable of using a mechanism to strengthen the decision to select the path of a branch from a response node of a state of a conversational graph, also taking into account the information of the state comprising the branch subsequent to the considered response node and possibly also the information of one or more states subsequent to the one comprising the branch.

It is also an object of the present invention a non-transitory computer readable storage medium as defined in the enclosed claim 10.

It is also an object of the present invention a computer program comprising software code portions adapted to perform the steps of the method for carrying out an automated conversation between a human user and a machine according to any of claims 1-9, when said program is run on at least one computer.

It is also an object of the present a conversational system, wherein the system is defined in the enclosed claim 11 and in the preferred embodiments described in the dependent claims from 12 to 15.

### BRIEF DESCRIPTION OF THE DRAWINGS

Further features and advantages of the invention will become more apparent from the description which follows of a preferred embodiment and the variants thereof, provided by way of example with reference to the appended drawings, in which:

FIG. 1 shows an example of conversational graph according to the invention;

FIG. 2 shows a block diagram of a conversational system according to the invention;

FIG. 3 shows a block diagram of the software architecture of a conversational engine included in the conversational system of FIG. 2;

FIG. 4 shows more in detail a block diagram of a neural network included in the conversational engine of FIG. 3;

FIG. 5 shows an alternative embodiment of a response classifier included in the conversational engine of FIG. 3;

FIG. 6 shows a diagram of the method for carrying out an automated conversation between human and machine according to the invention.

### DETAILED DESCRIPTION OF THE INVENTION

It should be observed that, in the following description, identical or analogous blocks, components or modules are indicated in the figures with the same numerical references, even if they are shown in different embodiments of the invention.

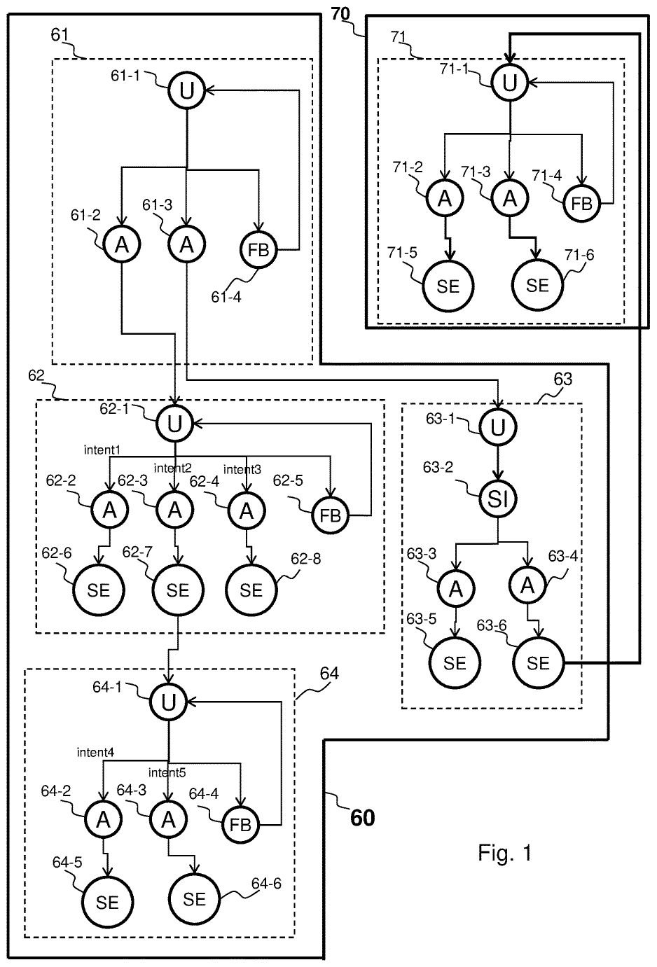

With reference to FIG. 1, two possible conversational graphs 60 and 70 according to the invention are shown, wherein each conversational graph is associated with a respective domain, i.e. a particular topic.

For example, the conversational graph 60 is associated with the topic sports, the conversational graph 70 is associated with the topic politics.

The conversational graph 60 represents a description of a flow of an automated conversation related to a certain conversation domain between a human user and a machine (i.e. a virtual conversational agent).

In other words, the expression of a human user by means of a pronounced phrase defines a node in the graph 60 or 70 and each conversation between the human user and the machine can be represented as a sequence of nodes in the graph 60 or 70.

The structure of the graph 60 and 70 is defined in advance by the programmer in a configuration phase, for each possible conversation domain, then the structure of the graph 60 and 70 is stored in a response classifier or in a data structure, as will be explained more in detail below.

By the term “domain” of the speech reference is made to characteristics or conventions of use of the language which are determined by the context in which the communication takes place, such as for example:
weather forecasts;
kitchen;
sports;
free time;
politics;
healthcare;

In other words, “domain” is defined as the application-specific context for the interaction of the human user with a virtual conversational agent. This determines the specific competency, the attitude, and the ecosystem for the Al management of the conversation of a dialogue session. In addition, the domain identifies a user destination or a group of user destinations. In an open domain, the topic of the conversation could be anything, and a user can jump from one topic to the other in the conversation.

When the operation of a conversational system is activated for the first time, the conversation domain is identified through analysis of the first phrase pronounced by the human user.

FIG. 1 shows for simplicity's sake a graph 70 (different from the graph 60) comprising a single state 71 and associated with a conversational domain different from the one associated with the graph 60; more generally, a plurality of different conversational graphs have been defined, each associated with a different domain and therefore at the beginning of the conversation it is identified which one is the domain (and thus the graph) associated with the phrase pronounced by the human user.

It is therefore assumed that the conversational system is initialized with the domain associated with the conversational graph 60.

The conversational graph 60 comprises a plurality of user nodes and a plurality of agent nodes, which are organized into a plurality of states.

In particular, the graph 60 comprises four states 61, 62, 63, 64 which are connected with the following logic:
from the state 61, it is proceeded to the state 62 or state 63;
from the state 62, it is proceeded to the state 64 or the conversation is ended at node 62-6 or node 62-8;
in the state 63 the conversation ends in node 63-5 or in node 63-6;
in the state 64 the conversation ends in node 64-5 or in node 64-6.

Each state comprises a user node and at least one agent node.

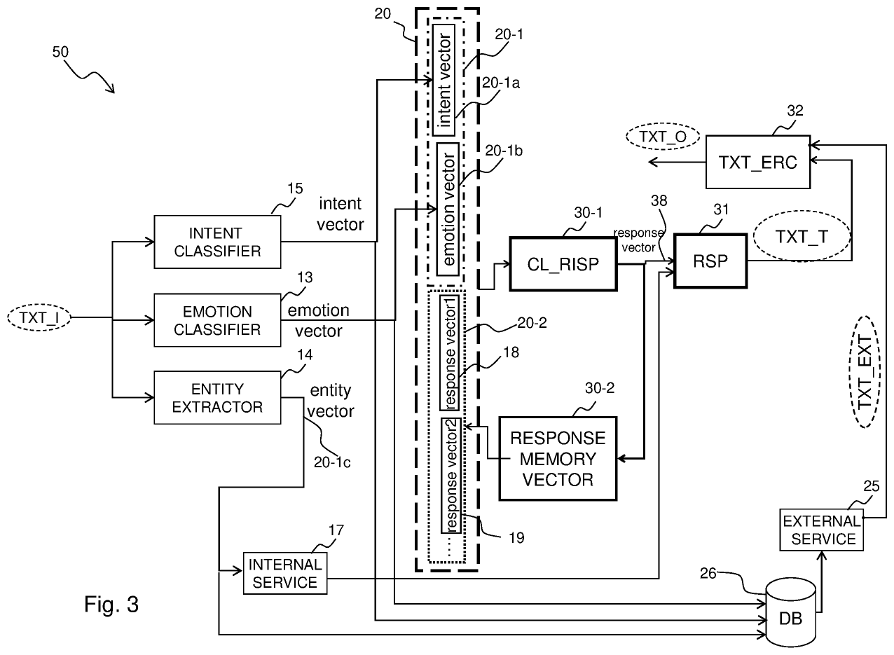

In the event that the conversation is initiated by a human user, the user node is representative of a text of a phrase pronounced by the human user (i.e. the phrase is “mapped” in the user node) and each agent node is representative of a text of a phrase automatically generated by the virtual conversational agent in response to the phrase pronounced by the human user, wherein the phrase associated with the agent node is generated by means of a conversational engine 50 which will be illustrated more in detail below with reference to FIG. 3.

It should be observed that the conversation may also be initiated by a suitably programmed machine: in this case the agent node is representative of a text of a phrase automatically generated by the virtual conversational agent by means of the conversational engine 50 and each user node is representative of a text of a phrase pronounced by the human user in response to the phrase automatically generated by the agent node.

In particular:
the state 61 comprises a user node 61-1 and two agent nodes 61-2 and 61-3 associated with the user node 61-1;
the state 62 comprises a user node 62-1 and three agent nodes 62-2, 62-3 and 62-4 associated with the question node 62-1;
the state 63 comprises a user node 63-1 and two agent nodes 63-3 and 63-4 associated with the question node 63-1;
the state 64 comprises a user node 64-1 and two agent nodes 64-3 and 64-4 associated with the user node 64-1.

The state 61 is connected to the subsequent state 62 and is furthermore connected to the subsequent state 63, so the state 61 is prior to the state 62 and is also prior to the state 63.

In addition, the state 62 is connected to the subsequent state 64, so the state 62 is prior to the state 64.

The conversation flow of the graph 60 evolves from a user node to an agent node as a function of an intent identified in the respective phrase pronounced by the user, as will be explained more in detail below with reference to the description of FIG. 1.

By the term “intent” is meant a particular problem or an activity, a problem or a request to be solved or executed.

In one embodiment, the graph 60 evolves from the user node to the agent node further taking into account also an emotion identified in the respective phrase pronounced by the user, as will be explained more in detail below.

By the term “identified emotion” is meant the ability to detect human emotions within a text of a phrase pronounced by a human user, in order to generate responses appropriate to certain types of feelings or emotions.

In one embodiment, the graph 60 evolves from the user node to the agent node further taking into account also one or more entities identified in the respective phrase pronounced by the user, as will be explained more in detail below.

By the term “entity” is meant additional information relevant to the identified intent. For example, the text of the phrase associated with the user node 63-1 is assumed to be as follows:

“How long is a journey by train from Milan to Paris?”

The conversational engine 50 identifies the intent “train journey duration” and the following entities: “Paris”, “Milan”.

The conversational graph 60 starts with the user node 61-1 of the state 61, which is connected to two agent nodes 61-2 and 61-3 with two oriented arcs, wherein said connection is a function of the intent of the text associated with the user node 61-1: this means that after the human user has pronounced a phrase, the conversational engine identifies the intent of the phrase associated with the user node 61-1, which is used to select the text of the phrase associated with the agent node 61-2 or with the agent node 61-3.

Furthermore, the user node 61-1 is further connected to a fallback node 61-4 of the state 61 with an oriented arc from the user node 61-1 to the fallback node 61-4, which in turn is connected to the user node 61-1 with an oriented arc from the fallback node 61-4 to the user node 61-1: this means that in the event that the conversational engine identifies an intent not corresponding to the transition to the agent node 61-2 nor to the transition to the agent node 61-3, the conversational engine generates the text associated with the fallback node 61-4, in order to direct the human user to pronounce a new phrase.

The agent node 61-2 of the state 61 is connected to the subsequent state 62. In particular, the agent node 61-2 is connected to the user node 62-1 of the subsequent state 62 with an oriented arc from the agent node 61-2 to the user node 62-1: this means that after the conversational engine has generated a phrase associated with the agent node 61-2, the conversational engine can accept a subsequent phrase of the user associated with the user node 62-1.

The agent node 61-3 of the state 61 is connected to the subsequent state 63. In particular, the agent node 61-3 is connected to the user node 63-1 of the subsequent state 63 with an oriented arc from the agent node 61-3 to the user node 63-1: this means that after the conversational engine has generated a phrase associated with the agent node 61-3, the conversational engine can accept a subsequent phrase of the user associated with the user node 63-1.

The user node 62-1 of the state 62 is connected to the agent nodes 62-2, 62-3 and 62-4 with oriented arcs, wherein said connection is a function of the intent of the text associated with the user node 62-1: this means that after the human user has pronounced a phrase associated with the user node 62-1, the conversational engine identifies the intent of the phrase associated with the user node 62-1, which is used to select the text associated with the agent node 62-2 or with the agent node 62-3 or with the agent node 62-4.

It should be observed that it is possible to have states in which a user node is associated with any number of agent nodes: for example, there are two agent nodes in the states 61, 63 and 64, while there are three agent nodes in the state 62.

Furthermore, the user node 62-1 is further connected to a fallback node 62-5 of the state 62 with an oriented arc from the user node 62-1 to the fallback node 62-5, which in turn is connected to the user node 62-1 with an oriented arc from the fallback node 62-5 to the user node 62-1: this means that in the event that the conversational engine identifies an intent not corresponding to the transition to the agent node 62-2, nor to the transition to the agent node 62-3, nor to the transition to the agent node 62-4, the conversational engine generates the text associated with the fallback node 62-5, in order to direct the human user to pronounce a new phrase.

The user node 63-1 of the state 63 is connected (directly or indirectly) to the agent nodes 63-2, 63-4 with oriented arcs, wherein said connection is a function of the intent of the text associated with the user node 63-1: this means that after the human user has pronounced a phrase associated with the user node 63-1, the conversational engine identifies the intent of the phrase associated with the user node 63-1, which is used to select the text associated with the agent node 63-3 or with the agent node 62-3 or with the agent node 63-4.

The user node 64-1 of the state 64 is connected to two agent nodes 64-2 and 64-3 with two oriented arcs, wherein said connection is a function of the intent of the text associated with the user node 64-1: this means that after the human user has pronounced a phrase, the conversational engine identifies the intent of the phrase associated with the user node 64-1, which is used to select the text associated with the agent node 64-2 or with the agent node 64-3.

Furthermore, the user node 64-1 is further connected to a fallback node 64-4 of the state 64 with an oriented arc from the user node 64-1 to the fallback node 64-4, which in turn is connected to the user node 64-1 with an oriented arc from the fallback node 64-4 to the user node 64-1: this means that in the event that the conversational engine identifies an intent not corresponding to the transition to the agent node 64-2 nor to the transition to the agent node 64-3, the conversational engine generates the text associated with the fallback node 64-4, in order to direct the human user to pronounce a new phrase.

The conversational graph 60 further comprises at most one fallback node for each state of the graph 60, as previously illustrated for the fallback nodes 61-4, 62-5, 64-4 in the states 61, 62, and 64, respectively. Some states may not have fallback nodes, such as for example illustrated for the state 63 of the conversational graph 60.

The fallback node has the function of generating a fallback phrase in the event that no intent is identified among those associated with the transitions to the agent nodes of the graph considered, in order to direct the human user to pronounce a new phrase correlated to the current state.

For example, in the event that the agent node 61-2 has selected the phrase: “Do you prefer travelling by train, by plane or by car?”, the user node 62-1 will process the phrase pronounced by the user predicting the user's intent:
in the event that the user pronounces the phrase “I prefer travelling by train”, the conversational engine will predict the intent class “train” (intent1) and will select the agent node 62-2 to continue the conversation;
in the event that the user pronounces the phrase “I prefer travelling by plane”, the conversational engine will predict the intent class “plane” (intent2) and will select the agent node 62-3 to continue the conversation;
in the event that the user pronounces the phrase “I prefer travelling by car”, the conversational engine will predict the intent class “car” (intent3) and will select the agent node 62-4 to continue the conversation;
in the event that the user pronounces a not correlated phrase (such as for example “What is the weather like tomorrow in Milan?”), the conversational engine will select the fallback node 62-5, whose aim is to rephrase the previous phrase, for example by generating the following phrase: “I have not understood. Do you prefer booking a plane ticket, a train ticket or renting a car?”

In one embodiment, the conversational graph 60 provides for the possibility of managing an operation with parameters associated, subsequent to a phrase pronounced by the user. In this case the conversational graph 60 further comprises at least one internal service node interposed between a user node and the respective agent nodes, as shown with the internal service node 63-2 in the state 63.

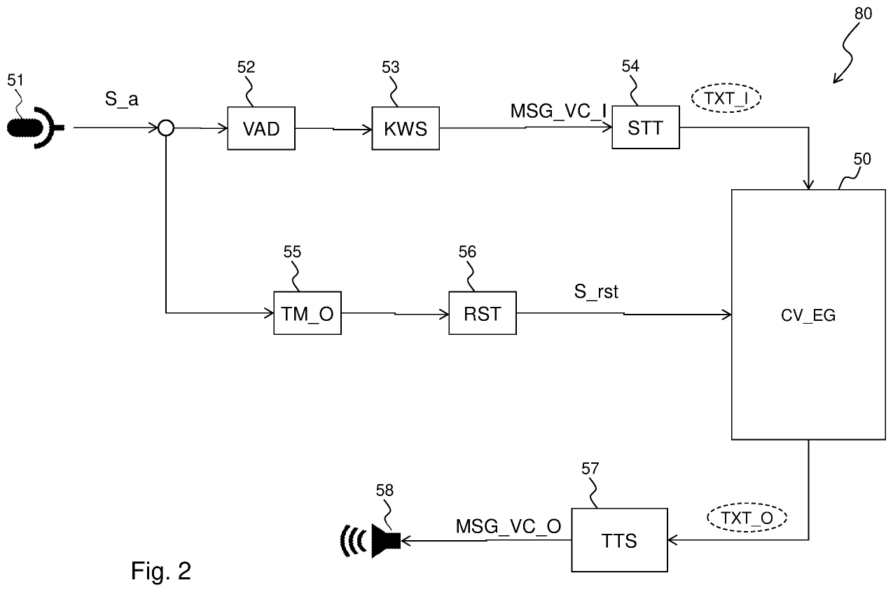

The internal service node has the function of switching the conversational system 80 (which will be illustrated below with reference to the description of FIG. 2) into particular and defined states of the conversation, activating a particular processing state taking into account the analysis of a feeling, emotion or entity of the phrase pronounced by the human user, in addition to the intents identified in the phrase pronounced by the human user.

In the state 63 an internal service node 63-2 is interposed between the user node 63-1 and the agent nodes 63-3 and 63-4 therefore:
the user node 63-1 is connected to the internal service node 63-2 with an oriented arc from the user node 63-1 to the internal service node 63-2;
the internal service node 63-2 is connected to the agent node 63-3 with a respective oriented arc;
the internal service node 63-2 is further connected to the agent node 63-4 with a respective oriented arc.

In one embodiment, the internal service node 63-2 retrieves the text associated with the user node 63-1, analyses the retrieved text and generates a processed text that is provided to the agent node 63-3 (or 63-4): in this way the text associated with the agent node 63-3 (or 63-4) is modified with respect to the predefined one for the agent node 63-3 (or 63-4), thus obtaining a better modified text, that is, one that most resembles the natural language of humans.

In one embodiment, the internal service node 63-2 switches the conversational system into a free conversation mode in which the human user can pronounce a free response (i.e. any phrase): in this case the conversational system automatically selects a phrase by means of an algorithm (different from the response classifier 30-1 illustrated below) as a consequence of the free response pronounced by the human user, then resuming the conversation from one of the connected states subsequently to the considered state. This embodiment is for example shown in the state 63 comprising the internal service node 63-2 interposed between the user node 63-1 and two agent nodes 63-3 and 63-4.

In particular, in the free conversation mode the conversational system performs an emotional profiling of the phrase pronounced by the user with the free response and a phrase associated with one of the agent nodes 63-3, 63-4 is automatically selected by means of an emotional response classifier (different from the response classifier 30-1 illustrated below) which receives in input the emotions identified in the phrase pronounced by the user with the free response.

For example, in the event that the agent node 61-3 has selected the phrase “Would you like to go shopping?”, the phrase pronounced by the user associated with the user node 63-1 will be processed and a prediction of the user's emotion will be made:
in the event that the user pronounces the phrase “I can't wait!”, the conversational system will profile (by means of the emotion classifier 13) said phrase perceiving positive emotions of the human user and the emotional response classifier will select, as a function of the positive emotion identified, the agent node 63-3 to continue the conversation;
in the event that the user pronounces the phrase “If I have to.”, the conversational system will profile (by means of the emotion classifier 13) said phrase perceiving negative emotions of the human user and the emotional response classifier will select, as a function of the negative emotion identified, the agent node 63-4 to continue the conversation.

The internal service node 63-2 is configured to save in a database 26 the information (entity) that has been extracted from the text of the phrase pronounced by the human user. In other words, after the human user has pronounced a phrase associated with the user node 63-1, the conversational engine 50 identifies (by means of an entity extractor 14 illustrated below) some entities in the text of the phrase associated with the user node 63-1, in addition to classifying the intent from the same text of the phrase associated with the user node 63-1, then the identified entities are saved in the database 26.

Consider again as an example the following text associated with the user node 63-1:

“Is it possible to travel to Paris by train leaving from Milan?”

In this example, the text associated with the agent node 63-3 can be as follows:

“Yes, it is possible to reach Paris by train leaving from Milan”

The conversational engine identifies (by means of the entity extractor 14) the entities “Paris” and “Milan”, which are saved in the database 26.

In another embodiment, the internal service node 63-2 switches the conversational system into a state of selection among some options, wherein the human user is forced to pronounce a predefined entity, such as for example numbers.

In another embodiment, the internal service node 63-2 has the further function of providing, after the human user has spoken, the possibility to interact with other systems, for example so as to profile the human user or to send a message or an event or to save data in a database.

In one embodiment, the conversational graph 60 provides for the possibility of managing an operation subsequent to an agent node, wherein said operation is defined in a configuration phase of the conversational graph 60 and can use data acquired previously during the conversation, such as for example the intents and/or the entities. In this case the conversational graph 60 further comprises at least one external service node each connected to a respective agent node, as shown in the external service nodes 62-6, 62-7, 62-8 of the state 62, in the external service nodes 63-5, 63-6 of the state 63 and in the external service nodes 64-5, 64-6 of the state 64.

The external service node has the function of making a request to an external service, such as for example a public Application Program Interface (API).

In particular, the state 62 comprises the external service node 62-6, which is connected to the agent node 62-2 of the state 62 with an oriented arc from the agent node 62-2 to the external service node 62-6; after the conversational engine has generated a phrase associated with the agent node 62-2, the conversational engine sends a request to an external service before proceeding with the conversation.

In other words, the external service is activated after the phrase associated with the agent node 62-2 has been identified and an interaction with external or internal systems occurs; after the interaction has occurred, data or states are saved in the conversational system, then the saved data are used at the subsequent state of the conversation to generate a response different from the predefined one associated with the agent node 62-2 of the conversational graph 60.

Similarly, the state 62 further comprises the external service nodes 62-7, 62-8 connected respectively to the agent nodes 62-3, 62-4 with respective oriented arcs, wherein the external service nodes 62-7 and 62-8 have a function similar to the external service node 62-6 illustrated above.

For example, in the event that the agent node 61-2 has selected the phrase “Would you like to pay for the pass now?”, the user node 62-1 will process the phrase pronounced by the user predicting the intent of the user having the highest probability:
in the event that the user pronounces the phrase “Yes”, the conversational engine will classify and identify the intent to “affirm” as the one having the highest probability and will select the agent node 62-2: in this case the external service node 62-6 will send a request for payment of the pass which is being talked about and will end the conversation;
in the event that the user pronounces the phrase “No, I want to cancel the pass”, the conversational engine will classify and identify the intent to “deny” as the one having the highest probability and will select the agent node 62-7 to continue the conversation: in this case the external service node 62-7 will send a request to cancel the pass it is being talked about and subsequently the conversation will continue with the state 64;
in the event that the user pronounces the phrase “Remind me later”, the conversational engine will classify and identify the intent to “postpone” as the one having the highest probability and will select the agent node 62-4: in this case the external service node 62-8 will set a reminder to remind the user to pay for the pass and will end the conversation.

The state 63 of the graph 60 comprises the external service node 63-5 connected to the agent node 63-3 with an oriented arc from the agent node 63-3 to the external service node 63-5, wherein the external service node 63-5 has a function similar to the external service node 62-6 illustrated above.

The state 63 of the graph 60 further comprises the external service node 63-6 connected to the agent node 63-4 with an oriented arc from the agent node 63-4 to the switching node 63-6, which in turn is connected to the user node 71-1 of the graph 70 with an oriented arc from the switching node 63-6 to the user node 71-1.

The external service node 63-6 is configured so as to switch the conversation from the conversational graph 60 to the conversational graph 70: in this way it is possible to change the topic of the conversation by passing from the topic associated with the graph 60 (for example, sports) to the topic associated with the graph 70 (for example, politics). The state 64 of the graph 60 comprises the external service nodes 64-5 and 64-6 connected respectively to the agent nodes 64-2 and 64-3 with respective oriented arcs, wherein the external service nodes 64-5 and 64-6 have a function similar to the external service node 62-6 illustrated above.

The state 71 of the graph 70 comprises the external service nodes 71-5 and 71-6 connected respectively to the agent nodes 71-2 and 71-3 with respective oriented arcs, wherein the external service nodes 71-5 and 71-6 have a function similar to the external service node 62-6 illustrated above.

With reference to FIG. 2, a block diagram of a conversational system 80 according to the invention is shown.

The conversational system 80 is made, for example, by means of a mobile or fixed type electronic device, such as for example a fixed personal computer, a portable personal computer, a smartphone, an iPhone, a tablet, an iPad or any other mobile electronic device.

The conversational system 50 comprises the serial connection of a microphone 51, a voice activation unit 52, a keyword detector 53, a voice/text converter 54 and a conversational engine 50.

The conversational system 50 further comprises the serial connection of a time measurement unit 55 and of a reset unit 56.

Finally, the conversational system 50 comprises the serial connection of a text-to-voice converter 57 and of a loudspeaker 58.

In particular, the microphone 51 has the function of acquiring a sound signal generated by the human user representative of a question or of a phrase pronounced by the human user, then the sound signal is converted into a voice signal of analogue voltage, which is then suitably sampled to generate a digital type audio signal.

The voice activation unit 52 is a hardware/software component having the function of verifying whether a question or a phrase has been pronounced by the human user, for example by verifying whether the power of the detected audio signal is greater than a threshold value.

The keyword detector 53 is a software component having the function of detecting the presence of a defined phrase (i.e. an activation word or phrase) in the detected audio signal, in order to activate the operation of the conversational system 80 in the inference mode.

The defined phrase can be for example “Hey IIO”.

The voice/text converter 54 is a software module having the function of performing a conversion of a voice message into a text message.

In particular, the voice/text converter 54 is configured to receive in input a voice message representative of a question or of a phrase pronounced by the human user interacting with the conversational system 80 and is configured to generate in output an input text TXT_I representative of the question or phrase pronounced by the human user.

The conversational engine 50 receives in input a text TXT_I representative of a phrase pronounced by the human user and generates in output a text TXT_O representative of a phrase automatically generated by means of the graph 60 and the conversational engine 50, as will be explained more in detail below relatively to the description of FIG. 3.

Furthermore, the conversational engine 50 receives in input a reset signal S_rst having the function of resetting the state of the conversational engine in case of an active value (for example, a transition from a low to high logical value), i.e. the state of the conversational graph 60 is restored to the user node 61-1.

The text-to-voice converter 57 has the function of performing the conversion of a text message into a voice message.

In particular, the text-to-voice converter 57 is configured to receive in input the output text TXT_O of the automatically generated phrase and is configured to generate in output an output voice message MSG_VC_O (e.g., an analogue voltage signal) representative of the automatically generated phrase.

The text-to-voice converter 57 comprises a front-end converter and a back-end synthesizer. The front-end converter carries out the text normalization, the pre-processing, or the tokenization by converting the not processed text containing symbols such as numbers and abbreviations into the equivalent of written words. The front-end converter then assigns the phonetic transcriptions to each word and divides and marks the text into prosodic units, such as phrases, clauses, and phrases. The process of assigning the phonetic transcriptions to the words is called text-to-phoneme or grapheme-to-phoneme conversion. The phonetic transcriptions and the prosody information together constitute the symbolic linguistic representation that is emitted by the front-end converter. The back-end synthesizer then converts the symbolic linguistic representation into sound.

The loudspeaker 58 has the function of receiving in input the output voice message MSG_VC_O and of generating therefrom in output a sound signal indicative of the automatically generated phrase.

The time measurement unit 55 has the function of measuring the value of a time interval starting from the instant in which a sound signal is detected by the microphone 51.

The time measurement unit 55 can be made in hardware (for example, it is a counter) or with a software module.

The reset unit 56 has the function of generating the reset signal S_rst having a transition from a logical value to another, when the measured value (by means of the time measurement unit 55) of the time interval has reached a defined configuration value (for example, equal to 10 seconds) or when a conversation has been completed.

With reference to FIG. 3, a block diagram of the software architecture of the conversational engine 50 according to the invention is shown.

The conversational engine 50 is made by means of a suitable software module of a software program and comprises a plurality of software sub-modules shown in FIG. 3, wherein the software program is run by means of a processing unit, for example a microprocessor of a fixed personal computer, a portable personal computer or a mobile electronic device (for example, a smartphone, a tablet, an iPhone, an iPad).

The software program can also be run on specific devices provided with the basic components for execution such as for example microphones, loudspeaker, CPU, memory, disk and network communication system.

The conversational engine 50 is executed for each of the states 61, 62, 63, 64, 71 previously indicated in the conversational graph 60 and 70 of FIG. 1.

Consider for example the state 61: the conversational engine 50 receives in input the text of the phrase of the human user associated with the user node 61-1 and then the conversational engine 50 generates in output the text of the phrase associated with the agent node 61-2 or 61-3 or the text associated with the fallback node 61-4.

Similarly:
in the state 62 the conversational engine 50 receives in input the text of the phrase associated with the user node 62-1 and then the conversational engine 50 generates in output the text of the phrase associated with the agent node 62-2 or 62-3 or 62-4 or the text associated with the fallback node 62-4;
in the state 63 the conversational engine 50 receives in input the text of the phrase associated with the user node 63-1 and then the conversational engine 50 generates in output the text of the phrase associated with the agent node 63-32 or 63-4;
in the state 64 the conversational engine 50 receives in input the text of the phrase associated with the user node 64-1 and then the conversational engine 50 generates in output the text of the phrase associated with the agent node 64-2 or 64-3 or the text associated with the fallback node 64-4.

In one embodiment using AI techniques, the conversational engine 50 is first executed in a training mode in order to learn the structure of the graph 60 and 70 by means of a response classifier 30-1 and then is executed in a subsequent inference phase in which a phrase is automatically generated in output in response to a phrase pronounced by the human user.

The conversational engine 50 comprises:
an intent classifier 15;
an emotion classifier 13;
the response classifier 30;
a vectors-text converter 31;
an entity extractor 14;
an internal service executor 17;
an external service executor 25;
a database 26;
a text enricher 32.

It should be observed that the presence of the emotion classifier 13, entity extractor 14, internal service executor 17, external service executor 25, database 26 and text enricher 32 is not essential, i.e. for example the following embodiments are possible:
first embodiment: comprises the intent classifier 15, response classifier 30, converter 31;
second embodiment: further comprises (in addition to the elements of the first embodiment) the emotion classifier 13;
third embodiment: further comprises (in addition to the elements of the first or second embodiment) the entity extractor 14 and the internal service executor 17;
fourth embodiment: further comprises (in addition to the elements of the third embodiment) the external service executor 25, the database 26 and the text enricher 32.

For the purposes of explaining the invention, the fourth embodiment shown in FIG. 3 will be illustrated below.

The intent classifier 15 is a software module that is executed for each of the states 61, 62, 63, 64, 71 of the conversational graphs 60 and 70 and has the function of performing, during the inference operation phase, an intent classification of the input text TXT_I representative of the phrase pronounced by the human user associated with a user node of the conversational graph 60 or 70, generating in output a number vector of the intents 20-1a indicative of the identified intent; more in particular, each value of the number vector of the intents 20-1a indicates a probability that the phrase pronounced belongs to a determined intent class and furthermore the intent classifier 15 generates in output a representation of which one is the intent class having the highest probability.

In one embodiment, the intent classifier 15 comprises a deep neural network configured to receive the input text TXT_I and to perform the intent classification of the input text TXT_I, generating in output the number vector of the intents 20-1a.

Embodiments of the intent classifier 15 include, but are not limited to, deep neural networks with word and subword embedding levels (e.g., using sentence vectors), fully connected convolutional, pooling, recurring, attention levels.

For example, the intent classifier 15 is made with the PyTorch or TensorFlow library.

The emotion classifier 13 is a software module that is executed for one or more of the states 61, 62, 63, 64, 71 of the conversational graphs 60 and 70 and has the function of performing, during the inference operation phase, a classification of the emotions of the input text TXT_I representative of the phrase pronounced by the human user associated with a user node of the conversational graph 60 or 70, generating in output a number vector of the emotions 20-1b indicative of at least one identified emotion; more in particular, each value of the number vector of the emotions 20-1b indicates a probability that the pronounced phrase belongs to a determined emotion class and furthermore the emotion classifier 13 generates in output a representation of which one is the emotion class having the highest probability.

The embodiments of the emotion classifier 13 are similar to those of the intent classifier 15.

For example, the emotion classifier 13 is made with the pytorch or tensorflow library.

The logic of the data on the user's emotions is, for example, derived on the basis of Plutchik's model, called the “wheel of emotions”. This taxonomy, in use since 1979, aims to classify the human emotions as a combination of four dualities: Joy-Sadness, Anger-Fear, Trust-Disgust and Surprise-Anticipation.

The entity extractor 14 is a software module that is executed for one or more of the states 61, 62, 63, 64, 71 of the conversational graphs 60 and 70 and has the function, during the normal operation or inference phase, of identifying an entity in the input text TXT_I representative of the phrase pronounced by the human user associated with a user node of the conversational graph 60 or 70, generating in output a number vector of the entities 20-1c indicative of the identified entity; more in particular, each value of the number vector of the entities 20-1c indicates a probability that a word or subword of the pronounced phrase belongs to a determined class of entities and furthermore the entity classifier 14 generates in output a representation of which one is the class of entities having the highest probability for each word or subword of the input text TXT_I.

The embodiments of the entity classifier 14 are similar to those of the intent classifier 15 and of the emotion classifier 13.

For example, the entity classifier 14 is made with the Pytorch or TensorFlow library.

The response classifier 30-1 is a software module that is executed for each of the states 61, 62, 63, 64, 71 of the conversational graphs 60 and 70 and has the function of storing the structure of the conversational graph 60 and 70, that is, all the possible paths through the conversational graph 60 starting from the node 61-1 up to the possible output nodes 62-6, 62-8, 63-5, 63-6, 64-5 and 64-6, 71-5, 71-6.

In one embodiment, the response classifier 30-1 is made with a deep neural network and the conversational engine 50 comprises a response memory 30-2 connected to the output of the response classifier 30-1.

For example, the neural network response classifier 30-1 is made with the Pytorch or TensorFlow library.

The response classifier 30-1 is configured to receive in input a composite number vector 20 and generate in output a number vector of the response 38 representative of at least part of the text of the phrase associated with the agent node of the considered state of the conversational graph 60.

In particular, the composite number vector 20 comprises the union (e.g., concatenation) of a first number vector 20-1 and a second number vector 20-2, wherein:
the first number vector 20-1 comprises a first portion 20-1a formed by the number vector of the intents which is generated by means of the intent classifier 15;
the first number vector 20-1 possibly comprises a second portion 20-1b formed by the number vector of the emotions which is generated by means of the emotion classifier 13;
the second number vector 20-2 comprises one or more number vector of the response 18, 19, . . . , which are representative of one or more number vectors of the response 38 generated previously in output by the response classifier 30-1 in the training phase or in the inference phase, as will be explained more in detail below.

Considering the example of the conversational graph 60, the response classifier 30-1 generates in output the number vector of the response 38, i.e., a number vector representative of the text of the phrase associated with the agent nodes 61-2, 61-3, 62-2, 62-3, 62-4, 63-3, 63-4, 64-2, 64-3, 71-2, 71-3.

The response memory 30-2 has the function of storing one or more number vectors of the response 18, 19, . . . representative of the number vectors of the response 38 generated previously in output by the response classifier 30-1 in the training or inference phase or in a phase of normal operation.

Consider for example the user node 62-1 of the state 62: in this case the response memory 30-2 stores a number vector representative of the text of the phrase associated with the agent node 61-2, since the state 61 is the one prior to the considered state 62 and the agent node 61-2 belongs to the state 61 and is connected to the considered user node 62-1 of the state 62. In this example the response classifier 30-1 is configured to select the text of the phrase associated with the agent node 62-2 or 62-3 or 62-4 by taking into account not only the number vector of the intents 20-1a representative of the probability of the first, second and third intent (intent1, intent2, intent3) identified in the text of the phrase associated with the user node 62-1 by means of the intent classifier 15, but by taking into account also the second number vector 20-2 comprising the number vector of the response 18 representative of the text of the phrase associated with the agent node 61-2 of the state 61 prior to the considered state 62: in this way it is possible to discriminate with more accuracy whether to perform a transition from the user node 62-1 to the agent node 62-2 or to the agent node 62-3 or to the agent node 62-4, thus increasing the accuracy of the identification of the intent in the phrase associated with the user node 62-1.

Consider another example of the state 64 having the user node 64-1: in this case the response memory 30-2 stores both a number vector representative of the text of the phrase associated with the agent node 62-3 (since the state 62 is the one prior to the considered state 64 and the agent node 62-3 belongs to the state 62 and is indirectly connected to the considered user node 64-1 of the state 64), and a number vector representative of the text of the phrase associated with the agent node 61-2 as illustrated in the previous example. In this example the response classifier 30-1 is configured to select the text of the phrase associated with the agent node 64-2 or 64-3- or 64-4 by taking into account not only the number vector of the intents 20-1a representative of the probability of the fourth and fifth intent (intent4, intent5) identified in the text of the phrase associated with the user node 64-1 by means of the intent classifier 15, but by taking into account also the second number vector 20-2 comprising the number vector of the response 18 representative of the text of the phrase associated with the agent node 62-3 of the state 62 prior to the considered state 64 and further comprising the number vector of the response 19 representative of the text of the phrase associated with the agent node 61-2 of the state 61 two times prior to the considered state 64.

More generally, in the inference phase the response classifier 30-1 is configured to select the phrase associated with an agent node of a state by taking into account not only the intents identified in the phrase associated with the user node of the considered state, but also the phrases associated with one or more agent nodes belonging to one or more states prior to the considered state, based on the connections between the states as defined by the topology of the graph 60.

The vectors-text converter 31 is a software module having the function of converting the number vector of the response 38 (generated by the response classifier 30-1) into a corresponding text representative of the phrase associated with an agent node 61-2, 61-3, 62-2, 62-3, 62-4, 63-3, 63-4, 64-2, 64-3, generating a temporary text TXT_T.

In other words, the conversational system 80 comprises a memory containing a table of the associations between the possible numerical values of the number vector of the response 30 (generated by the response classifier 30-1) and the corresponding values of the text of the phrase.

Furthermore, the vectors-text converter 31 is connected with the internal service executor 17 and receives therefrom a processed text, thus the vectors-text converter 31 generates at the output a modified text compared to the one generated by the response classifier 30-1: in this way, responses are obtained that are diversified (as well as coherent), which thus most resemble those between two human users.

The operation of the conversational engine 50 during the training phase, in which it is assumed to train the neural network response classifier 30-1 to learn the connection between the user node 62-1 of the state 62 and the agent node 62-2, will now be described below.

The neural network response classifier 30-1 receives in input a training dataset comprising a number vector of the intents 20-1a representative of the first, second and third intent (intent1, intent2, intent3) and a first known number vector of the response 38 representative of the text of the phrase associated with the agent node 62-2.

Furthermore, the neural network response classifier 30-1 receives in input the number vector of the response 18 representative of the text of the phrase associated with the agent node 61-2 of the state 61 prior to the considered state 62.

The parameters of the neural network response classifier 30-1 are then modified (in the training phase) so as to store the association between the user node 62-1 and the agent node 62-2 in the event that the first intent in the phrase associated with the user node 62-1 is identified (in the inference phase) as most probable, to store the association between the user node 62-1 and the agent node 62-3 in the event that the second intent in the phrase associated with the user node 62-1 is identified (in the inference phase) as most probable, and to store the association between the user node 62-1 and the agent node 62-4 in the event that the third intent in the phrase associated with the user node 62-1 is identified (in the inference phase) as most probable; in addition, the parameters of the neural network response classifier 30-1 are modified (in the training phase) so as to store the association between the agent node 61-2 of the state 61 and the user node 62-1 of the state 62.

Furthermore, the first number vector of the response 38 is stored in the response memory 30-2.

The operation of the conversational engine 50 during the inference phase will now be described below, assuming that the conversation between the human user and the conversational system has followed the path comprising the nodes 61-1, 61-2, 62-1, i.e. the current state of the conversation according to the graph 60 is equal to the user node 62-1.

The human user pronounces a phrase (e.g., a question) and the neural network response classifier 30-1 receives in input the composite number vector 20 comprising the number vector of the intents 20-1a (generated by the intent classifier 15 as a function of the input text TXT_I) representative of the probability of the first, second and third intent (intent1, intent2, intent3), receives in input the number vector of the response 18 representative of the text of the phrase associated with the agent node 61-2: the neural network response classifier 30-1 must then decide whether the composite number vector 20 corresponds to a transition from the user node 62-1 to the agent node 62-2 or to the agent node 62-3 or to the agent node 62-4 or to the fallback node 62-5.

It is assumed that the intent classifier 15 has detected the second intent (intent2) as the one having greater probability than the first and third intent (intent1 and intent3): the neural network response classifier 30-1 has previously stored (in the training phase) the association between the user node 62-1 and the agent node 62-3 in case of identification of the second intent as the one having greater probability, therefore the neural network response classifier 30-1 generates in output the number vector of the response 38 which is a vectorial representation of numbers representative of the text of the phrase associated with the agent node 62-3.

Furthermore, the number vector of the response 38 generated in output is stored in the response memory 30-2, so as to be used for calculation in the state 64 subsequent to the state 62, in order to determine in the user node 64-1 whether to perform a transition to the agent node 64-2 or to the agent node 64-3 or to the fallback node 64-4.

The internal service executor 17 is a software module internal to the conversational system 80 and it has the function of switching the conversational system 80 into particular processing states, i.e. the internal service executor 17 is executed in the internal service node 63-2 of the state 63 of the graph 60 illustrated above.

In one embodiment, the internal service executor 17 is configured to activate a free conversation mode in which the human user can pronounce a free response (i.e. any phrase): in this case the internal service executor 17 comprises an emotional response classifier configured to receive in input the number vector of the emotions 20-1b (generated by the emotion classifier 13) and generate in output a vector of numbers representative of the text of a phrase among those associated with the agent nodes 63-3 and 63-4.

The database 26 is a non-volatile memory which has the function of storing information correlated to the text of the phrase pronounced by the human user, for example the intent class predicted by the intent classifier 15, the emotion class predicted by the emotion classifier 13 and the entities extracted by means of the entity extractor 14: in this way it is possible to subsequently use the information of the identified intent class and/or identified emotion class and/or extracted entities, as will be explained more in detail below.

Alternatively, it is possible to use a volatile memory to store the information of the identified intent class and/or identified emotion class and/or extracted entities.

The external service executor 25 is a software module having the function of performing an operation configured in an external service node, such as for example sending a request to an external service, using the information (entities and/or intents) that has been obtained from the analysis of the text of the phrase pronounced by the human user.

The external service executor 25 implements the external service nodes 62-6, 62-7, 62-8, 63-5, 63-6, 64-5, 64-6 of the graph 60 and the external service nodes 71-5, 71-6 of the graph 70.

In particular, the external service executor 25 receives in input the number vector of the intents 20-1a representative of the intent class identified in the text of the phrase pronounced by the human user and receives, if requested, also the number vector of the entities representative of the entity class identified in the text of the phrase pronounced by the human user, reads from the database 26 the information correlated to the identified entities and/or intents and generates in output a command addressed to the selected external service.

Furthermore, the external service executor 25 generates at the output an external text TXT_EXT of a phrase correlated to the requested external service, thereby generating an output text TXT_O which is a combination of the text generated by the vectors-text converter 31 and of the external text TXT_EXT generated by the external service executor 25.

An example is the one in which the external service executor 25 accesses an external service by means of an API (Application Program Interface), for example a taxi booking service, using the information (entity) that has been obtained from the analysis of the text of the phrase pronounced by the human user, i.e. the address at which the taxi is requested. In this case, the external service executor 25 generates in output the external text TXT_EXT indicative of a taxi booking confirmation or rejection, such as for example “Taxi booked” or “Taxis not available for the requested address”.

Another example is the one in which the external service executor 25 accesses a pizza order service by means of a pizzeria's API, using the information (intents and/or entities) that has been obtained from the analysis of the text of the phrase pronounced by the human user, i.e. the intention to order a pizza and deliver it to/at a certain address and time. In this case, the external service executor 25 generates in output the external text TXT_EXT indicative of a pizza order confirmation or rejection, such as for example “Order confirmed” or “Order rejected”.

The enriched text generator 32 is a software module having the function of enriching the text of the response to the phrase pronounced by the human user, for example by completing information already present in the temporary text TXT_T or in the external text TXT_EXT or by changing the semantics of the temporary text TXT_T or of the external text TXT_EXT to make the language more similar to the human one.

For example, the entity extractor 14 has identified an entity that is the name of the human person who is carrying out the conversation with the conversational system 80: in this case the temporary text TXT_T comprises a “person” label representative of a generic name of the human user, then said label is replaced with the name identified by means of the entity extractor 14, thus generating the output text TXT_O that most resembles the human language, since the response also contains the name of the human person.

Another example is the one of the carbonara pasta recipe: in this case the database 26 stores the information necessary for the preparation of the carbonara pasta, in particular the ingredients and the preparation process, through the external service executor 25.

In this example, the external service executor 25 reads from the database 26 the entities classified by means of the entity extractor 14, such as for example “carbonara pasta”, “recipe”. Subsequently, the external service executor 25 receives the recipe from an external service and saves in the database 26 the information of the carbonara pasta recipe, i.e. the ingredients and the method of preparation. Finally, the enriched text generator 32 generates in output the output text TXT_O containing the list of the ingredients of the carbonara pasta and the steps of the preparation process thereof.

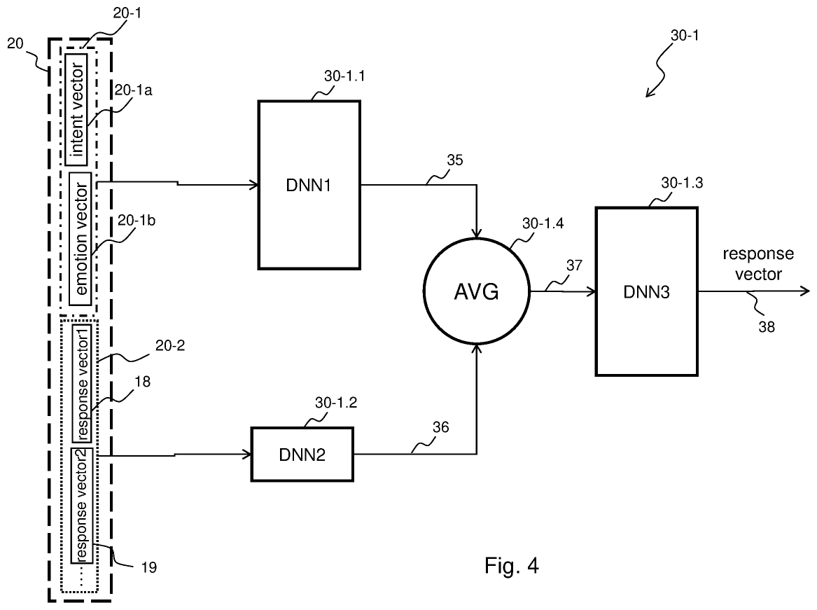

With reference to FIG. 4, a possible embodiment of the neural network response classifier 30-1 implemented with three deep neural networks 30-1.1, 30-1.2, 30-1.3 and a combination module 30-1.4, which are connected as shown in FIG. 4, is shown more in detail.

In particular, the composite number vector 20 comprises a linear combination of the number vector of the intents 20-1a, number vector of the emotions 20-1b and the number vectors of the responses 18, 19.

In a preferred embodiment, the deep neural network 30-1.1 is a neural network memory configured to provide the output 35 in order to expand the composite number vector 20 into a configurable number of saved states. The deep neural network 30-1.1 allows the question response-conversation response combiner to precisely match the correct response depending on the actual state of the conversation graph or of one or more conversation graphs.

The deep neural network 30-1.2 is a neural network memory configured to provide the output 36 incorporating a weight parameter of a user response to allow any modification to a memory vector to increase the accuracy of the intent classification and of the emotion classification. The outputs 35 and 36 are mediated together in the combination module 30-1.4 to generate an input 37 into the deep neural network 30-3.

The deep neural network 30-1.3 produces one or more number vectors of the responses 38 corresponding to a text associated with the agent nodes 61-2, 61-3, 62-2, 62-3, 62-4, 63-3, 63-4, 64-2, 64-3 or with the fallback nodes 61-4, 62-5, 64-4.

One or more number vectors of the responses 38 are reintroduced into the deep neural network 30-1.2 as subdivision to increase the importance of the weight in the deep neural network 30-1.3 to increase the possibility that the intent and emotion vector is classified accurately.

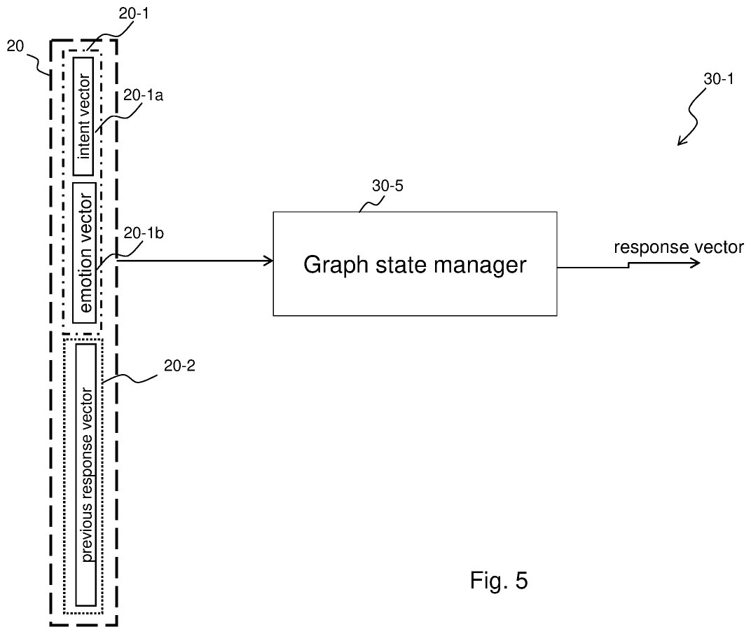

In an alternative embodiment, the response classifier 30-1 is carried out as shown in FIG. 5 and comprises a graph state manager 30-5 performing a search algorithm in the possible states of the conversational graph 60, wherein the conversational graph 60 is converted into a searchable dictionary of predefined conversation states.

In particular, the graph state manager 30-5 is configured to analyse the conversational graph 60 and to follow the correct branch, taking in input, for each state, the current intent class 20-1a identified in the text of the phrase considered, a previous response vector 20-2 representative of a phrase associated with the user node of the state prior to the one considered and possibly the fallback response of the considered state, generating in output a response vector representative of the text of the phrase associated with the selected agent node based on the topology of the graph 60.

By the term “intent class” is meant an alphanumeric value representative of the intent class associated with the input text TXT_I by means of the intent classifier 15.

Consider for example the state 62 having the user node 62-1 after which there is a bifurcation of the conversational graph 60 into three branches: the human user pronounces a phrase TXT_I and the graph state manager 30-5 receives in input the previous response vector 20-2 representative of the text of the phrase associated with the agent node 61-2 of the state 61 prior to the considered state 62, receives in input the intent class 20-1a (generated by the intent classifier 15 as a function of the input text TXT_I) indicative of the intents in the text corresponding to the user node 62-1. The graph state manager 30-5 must then decide whether the composite number vector 20 corresponds to a transition from the user node 62-1 to the agent node 62-2 or to the agent node 62-3 or to the agent node 62-4.

It is assumed that the intent classifier 15 has identified that the intent class “intent2” has a higher probability than the one of the intent class “intent1” and “intent3”: the graph state manager 30-5 then generates in output the response vector 38 which is a vectorial representation representative of the text of the phrase associated with the agent node 62-3.

Furthermore, the number vector of the response 38 (associated with the agent node 62-3) generated in output is feedbacked in input and stored in the memory 30-2, so as to be taken into consideration by the graph state manager 30-5 for the calculation of the number vector of the response 38 in output of the subsequent state 64.

Alternatively, it is assumed that the intent classifier 15 has identified as most probable the intent class “intent4” different from the intent class “intent1”, “intent2” and “intent3”: in this case the graph state manager 30-5 generates in output the number vector of the response 38 which is a vectorial representation representative of the text of the phrase associated with the fallback node 62-5.

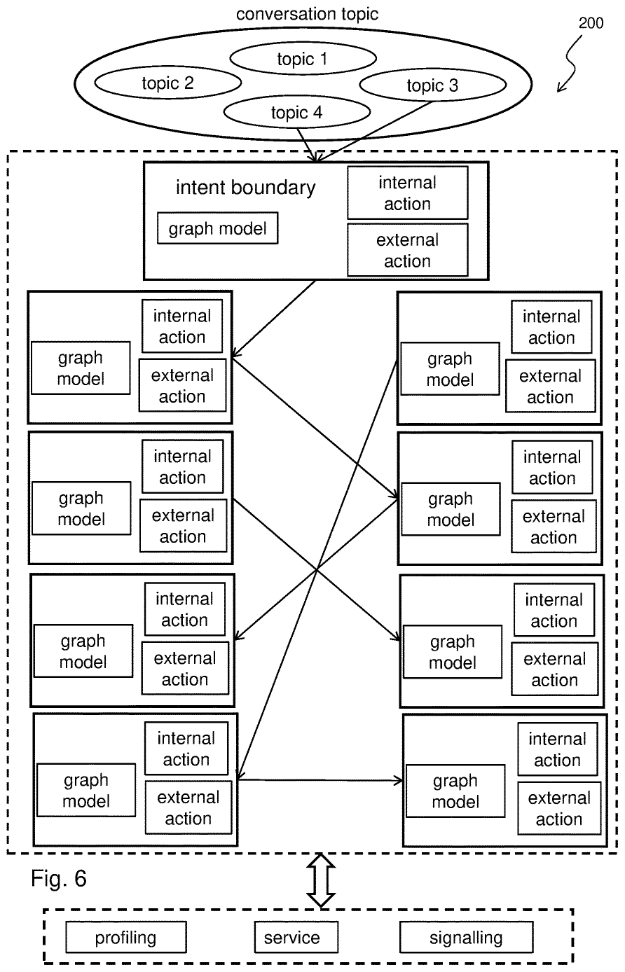

With reference to FIG. 6, a high-level diagram of the method for carrying out a conversation between human and machine according to the invention is shown.

The method provides for the management, for example, of four possible conversation topics indicated with “topic 1”, “topic 2”, “topic 3” and “topic 4”, in which each conversation topic is carried out in a respective conversation graph, as previously illustrated for the graphs 60 and 70.

In particular, each graph represents a particular development of a conversation topic in which the flow of the conversation is guided and therefore no deviations from the preset logic of the conversation are possible, i.e. any deviations are managed by fallback phrases whose aim is to bring the conversation back to the current state, as previously illustrated for the fallback nodes.

The method comprises the presence of a special initial state indicated with “intent boundary”, which has the function of managing the entry of the conversation; subsequently the method proceeds with the states present in the various graphs, in which each graph can access a series of services using the data extracted from the text of the conversation, such as for example the “profiling”, “service” and “signalling” services.

1-15. (canceled)

16. A computer-implemented method for carrying out an automated conversation between a user and a machine, the method comprising steps of:
a) providing, in a training phase prior to an inference phase or in a configuration phase prior to a normal operation phase, an oriented conversational graph representative of a user conversation flow in a defined conversation domain, the conversational graph comprising a plurality of successively connected states, wherein each state comprises at least one user node representative of a text of a phrase pronounced by the user and at least one agent node representative of a text of a respective at least one phrase automatically generated by a virtual conversational agent, wherein each user node is associated with at least one agent node as a function of a respective intent indicative of a task to be performed, a problem to be solved or a request to be made, an affirmation or a negation, the conversational graph comprising a first state having an agent node connected with a user node of a second state subsequent to the first state, wherein the user node of the second state is associated with at least two agent nodes as a function of respective intents;
b) training, in the training phase, a response classifier for storing the association between the user node and the at least one agent node of each state and between the agent node of one state and the user node of a subsequent state, or storing in the configuration phase a data structure representative of the association between the user node and the at least one agent node of each state and between the agent node of one state and the user node of a subsequent state;
c) in the inference phase or in the normal operation phase, receiving in input, at a voice-text converter, an input voice message indicative of a phrase pronounced by the user and converting said input voice message into an input text associated with a user node of the graph;
d) in the inference phase or in the normal operation phase, identifying at least two intents in the input text by means of an intent classifier and generating therefrom a number vector of the intents which is indicative of a probability of said at least two intents;
e) in the inference phase or in the normal operation phase, selecting, by means of a response classifier, the text of the phrase associated with an agent node from among the at least two agent nodes of the second state, taking into account the intent having a higher probability in said number vector of the intents and further taking into account a stored number vector of the responses representative of the text of the phrase associated with the agent node of the first state, generating therefrom a number vector of the response representative of the text of the phrase associated with the selected agent node of the second state;
f) converting, in the inference phase or in the normal operation phase, the number vector of the response into an output text representative of the selected text of the phrase associated with the agent node of the second state;
g) in the inference or normal operation phase, storing in a memory said number vector of the response representative of the selected text of the phrase associated with the agent node of the second state;
h) in the inference phase or in the normal operation phase, converting, by means of a text-voice converter, the output text into an output voice message.

17. The method according to claim 16,
wherein the step a) comprises providing the conversational graph comprising a state having an internal service node interposed between a user node and at least two agent nodes,
the step b) further comprising training the response classifier for storing an association between the user node and the internal service node and between the internal service node and the at least one agent node, or the step b) comprising storing in the configuration phase in the data structure the association between the user node and the internal service node and between the internal service node and the at least one agent node,
after the step f) or g), processing said output text by means of the internal service node and generating therefrom a modified output text, and
in the step h), converting said modified output text into the output voice message.

18. The method according to claim 16,
wherein the step a) comprises providing the conversational graph comprising a state having an internal service node interposed between a user node and at least one agent node, wherein the internal service node is configured to store information in a database,
the step b) further comprising training the response classifier for storing an association between said user node and the internal service node and between the internal service node and the at least one agent node, or step b) comprising storing in the configuration phase in the data structure the association between said user node and the internal service node and between the internal service node and the at least one agent node),
in the step d), identifying at least one entity in the input text by means of an entity extractor and generating therefrom a number vector of the entities which is indicative of the probability of the at least one entity, wherein each entity represents information relevant to the identified intent, and saving, by means of the internal service node, the number vector of the entities in a database.

19. The method according to claim 16,
wherein the step a) comprises providing the conversational graph comprising a state having an internal service node interposed between a user node and at least two agent nodes, wherein the internal service node is configured to perform an emotional profiling of the input text,
the step b) further comprising training the response classifier for storing an association between the user node and the internal service node and between the internal service node and the at least one agent node, or step b) comprising storing in the configuration phase in the data structure the association between the user node and the internal service node and between the internal service node and the at least one agent node,
in the step d) identifying at least two emotions in the input text by means of an emotion classifier, generating therefrom a number vector of the emotions which is indicative of the probability of at least two emotions;
the method further comprising performing an emotional profiling of the input text by means of an emotional response classifier of the internal service node and selecting therefrom the text of a phrase associated with an agent node between said at least two agent nodes; and
in the step f), generating an output text of the selected phrase associated with said agent node.

20. The method according to claim 16,
wherein the step a) comprises providing the conversational graph comprising a state having an external service node connected to an agent node, wherein the external service node is configured to make a request to an external service,
the step b) further comprising training the response classifier for storing an association between said agent node and the external service node, or the step b) comprising storing in the configuration phase in the data structure the association between said agent node and the external service node,
in the step d): identifying at least one entity in the input text by means of an entity extractor and generating therefrom a number vector of the entities which is indicative of the probability of the at least one entity, wherein each entity represents information relevant to the identified intent;
the method further comprising:
sending to an external service a request to an Application Program Interface for a service correlated to the entity having a higher probability in the number vector of the entities;
generating an external text of a phrase correlated to the requested external service and generating a further output text comprising a combination of said external text and of the output text generated by means of the conversion of the number vector of the response;
converting, by means of a text-to-voice converter, the further output text into a further output voice message.

21. The method according to claim 20, the method further comprising, after the step d):
reading from a database information correlated to the entity having a higher probability in the number vector of the entities; and
generating the output text of a phrase further comprising said information correlated to the entity.

22. The method according to claim 16,
wherein the step a) comprises providing the conversational graph comprising at least one state having a fallback node connected to a user node, wherein the fallback node is representative of a text of a fallback phrase automatically generated by the conversational agent to direct the user to pronounce a new phrase associated with a conversation domain associated with the conversational graph,
the step b) further comprising training the response classifier for storing an association between a user node and the fallback node, or storing in the configuration phase in the data structure the association between the user node and the fallback node,
the method further comprising, in the step e), detecting, by means of the response classifier, in the number vector of the intents an intent having a higher probability different from the intent associated between a user node and the respective at least one agent node;
the method further comprising, in the step f), generating the output text of the fallback phrase.

23. The method according to claim 20,
wherein the external service node is configured to switch the conversation from a first conversational graph associated with a first conversation domain to a second conversational graph associated with a second conversation domain,
the step b) further comprising training the response classifier for storing an association between the external service node of the first graph and an initial user node of the second graph, or storing in the configuration phase in the data structure the association between the external service node of the first graph and a user node of the second graph,
the method further comprising, in the step e), identifying in the input text the second conversation domain,
the method further comprising repeating steps c)-h) starting from the initial user node of the second graph.

24. The method according to claim 16, wherein the response classifier is made with at least one deep neural network.

25. A non-transitory computer-readable storage medium comprising instructions that, when executed on a computer, cause the computer to perform the steps of the method according to claim 16.

26. A conversational electronic system comprising:
a voice/text converter, a conversational engine and a text/voice converter,
wherein the voice/text converter is configured to receive an input voice message indicative of a phrase pronounced by a user and to convert said input voice message into an input text,
wherein the conversational engine comprises an intent classifier, a response classifier, a response memory and a vectors-text converter, the response classifier being configured to store, during a training phase prior to an inference phase, a topology of an oriented conversational graph representative of a user conversation flow in a defined conversation domain,
the conversational graph comprising a plurality of successively connected states, wherein each state comprises at least one user node representative of a text of a phrase pronounced by the user and at least one agent node representative of a text of a respective at least one phrase automatically generated by a virtual conversational agent,
wherein each user node is associated with at least one agent node as a function of a respective intent indicative of an activity to be performed, a problem to be solved or a request to be made, an affirmation or a negation, the conversational graph comprising a first state having an agent node connected with a user node of a second state subsequent to the first state,
wherein the user node of the second state is associated with at least two agent nodes as a function of respective intents;
the intent classifier being configured to identify, in the inference phase or in a normal operation phase, at least two intents in the input text and generate therefrom a number vector of the intents which is indicative of the probability of said at least two intents,
the response memory being configured to store a number vector of the responses representative of the text of the phrase associated with the agent node of the first state,
wherein the response classifier is further configured, in the inference or normal operation phase, to select the text of the phrase associated with an agent node from among the at least two agent nodes of the second state, taking into account the intent having a higher probability in said number vector of the intents and further taking into account said stored number vector of the responses representative of the text of the phrase associated with the agent node of the first state, generating therefrom a number vector of the response representative of the text of the phrase associated with the selected agent node of the second state,
wherein the response memory is further configured to store said number vector of the response representative of the text of the phrase associated with the selected agent node of the second state,
wherein the vectors-text converter is configured to convert said number vector of the response into an output text,
and wherein the text-to-voice converter is configured to convert the output text (TXT_O) into an output voice message.

27. The conversational electronic system according to claim 26,
the conversational graph comprising a state having an internal service node interposed between a user node and at least two agent nodes,
the conversational engine further comprising an internal service executor executed in the internal service node, the internal service executor being connected with the vectors-text converter,
wherein the internal service executor is configured to process said output text and generate therefrom a modified output text,
and wherein the text-to-voice converter is configured to convert said modified output text into the output voice message.

28. The conversational electronic system according to claim 26, the conversational graph comprising a state having an external service node connected to an agent node,
the conversational engine further comprising an entity extractor, a database connected to the entity extractor and an external service executor connected to the database, wherein the external service executor is executed in the external service node,
wherein the entity extractor is configured to identify at least one entity in the input text and generate therefrom a number vector of the entities which is indicative of the probability of the at least one entity, wherein each entity represents information relevant to the identified intent,
wherein the database is configured to save the number vector of the entities, wherein the external service executor is configured to:
send to an external service a request for a service correlated to the entity having a higher probability in the number vector of the entities, in particular to an Application Program Interface; generate an external text of a phrase correlated to the requested external service;
generate a further output text comprising a combination of said external text and of the output text generated by means of the vectors-text converter;
and wherein the text-to-voice converter is configured to convert the further output text into an output voice message.

29. The electronic conversational system according to claim 26,
wherein the conversational engine further comprises an entity extractor and a database,
wherein the entity extractor is configured to identify at least one entity in the input text and generate therefrom a number vector of the entities which is indicative of the probability of the at least one entity,
wherein each entity represents information relevant to the identified intent,
wherein the database is configured to save the number vector of the entities.

30. The electronic conversational system according to claim 27, wherein the conversational engine further comprises an emotion classifier configured to identify at least two emotions in the input text,
and wherein the conversational engine is further configured to perform an emotional profiling of the input text by means of an emotional response classifier of the internal service executor and select therefrom the text of a phrase associated with an agent node between at least two agent nodes.
